(19) United States
(12) Patent Application Publication
(10) Pub. No.: US 2009/0124335 A1
(43) Pub. Date: May 14, 2009

(54) METHOD, APPARATUS, AND PROGRAM PRODUCT FOR CONDUCTING A GAME HAVING A CONCURRENT BONUS INDICATOR

(76) Inventors: Brian A. Watkins, Austin, TX (US); Andrea R. Barton, Austin, TX (US)

Correspondence Address: THE CULBERTSON GROUP, P.C., 1114 LOST CREEK BLVD., SUITE 420, AUSTIN, TX, 78746, US

(21) Appl. No.: 12/132,451

(22) Filed: Jun. 3, 2008

Related U.S. Application Data
(60) Provisional application No. 60/987,612, filed on Nov. 13, 2007.

(51) Int. Cl. G06F 17/00

(52) U.S. Cl. 463/20; 463/31; 463/25

(57) ABSTRACT

A game, preferably a video-based reel-type game, is provided having a persistent bonus mode. Methods, gaming machines, and program products are provided in various embodiments. One preferred game includes displaying gaming graphics in a first region of a graphic display device. In response to entering a player-chosen participation mode, such as, for example, “max lines” betting, the game displays a potential bonus award level, which can be maintained in response to certain gaming events such that it applies to the next game play cycle. In response to a game event having a bonus-award type, the game awards an amount based on the potential bonus award level. In response to a game event having a bonus-adjust type, the game randomly selects a new potential bonus award level from among a set of potential levels. Various adjustments to the bonus level may also be made in response to player bet-level changes.

### CROSS-REFERENCE TO RELATED APPLICATION

The Applicants claim the benefit, under 35 U.S.C. § 119(e), of U.S. Provisional Patent Application Ser. No. 60/987,612 filed Nov. 13, 2007, and entitled “Method, Apparatus, and Program Product for Conducting a Game Having a Concurrent Bonus Indicator.” The entire content of this provisional application is incorporated herein by this reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights.

### TECHNICAL FIELD OF THE INVENTION

The present invention relates to gaming machines, programs, and methods for providing a potential bonus prize that persists between game play cycles and may be adjusted by game play outcomes.

### BACKGROUND OF THE INVENTION

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Video-based gaming machines may also be used to show card games or various types of competitions, such as simulated horse races, in which wagers may be placed. Game manufacturers are continuously pressed to develop new game presentations, formats, and game graphics in an attempt to provide high entertainment value for players and thereby attract and keep players.

### SUMMARY OF THE INVENTION

The present invention includes a highly entertaining method of presenting games to a player. The entertainment value is achieved by presenting a game, preferably a video-based reel-type game, having a persistent bonus mode. The present invention also encompasses methods for operating a gaming machine as well as both apparatus and program products for implementing the gaming machine operation methods.

A method embodying principles of the invention may be implemented in a gaming machine using one or more display devices such as CRTs, LCDs, plasma displays, or other types of video display devices. The display device or devices are used to show graphic elements. As used in this disclosure and the accompanying claims, a gaming machine through which the present invention may be implemented will be referred to generally as a gaming machine regardless of the nature of the display device arrangement used to show results to the player.

One preferred method includes operating a gaming machine by displaying gaming graphics in a first region of a graphic display device. In response to entering a player-chosen participation mode, such as, for example, “max lines” betting, the method displays a potential bonus award level. In response to a game event having a first bonus-persists type, the method maintains the potential bonus award level such that it applies to the next game play cycle. In response to a game event having a second bonus-award type, the method awards an amount based on the potential bonus award level. In response to a game event having a third bonus-adjust type, the method randomly selects a new potential bonus award level from among a set of potential levels.

In another embodiment of the invention, a method includes displaying a matrix of symbol locations in a first display region, the symbol locations for displaying symbols based on game events. In response to entering a player-chosen maximum line participation mode, the method displays a potential bonus award level in a second display region. After displaying the potential bonus award level, the method provides a game play cycle in which a non-bonus game prize is awarded and the potential bonus award level is maintained for use in a subsequent game play cycle.

One preferred apparatus according to the invention is a gaming machine including a video display device, a player interface, and a presentation controller. The presentation controller is for (i) causing the video display device to display a gaming graphic in a first region, for (ii) in response to entering a player-chosen maximum line participation mode, causing the video display device to display a potential bonus award level in a second display region of the graphic display device, and for (iii) in response to a game event having a first bonus-persists type, maintaining the potential bonus award level display for application to a subsequent game play cycle. The game may also adjust or award the potential bonus. Other gaming devices according to the invention perform other methods disclosed herein.

One preferred program product according to the invention provides a program embodied in one or more computer readable media. The program product includes first game program code executable to cause a gaming machine to operate in a game play mode in which a game display device displays a gaming graphic in a first region of a game display device. The product also includes second game program code executable to cause a gaming machine to operate in a bonus mode in which a game display device displays a potential bonus award level. Depending on events in the game, the program product may cause the potential bonus to be awarded, or to be maintained for availability in subsequent game play cycles. In response to an event calling for a bonus adjustment, the program product causes the game to randomly select a new potential bonus award level from among a set of potential levels.

In various embodiments, the invention may have one or more of the following features. Entering the bonus mode may be a result of the player choosing the “maximum lines” participation mode in a reel-type slot machine. When the player chooses sub-maximum line participation level, the game may remove the potential bonus award level. In response to the player adjusting their bet level, the game may modify the potential bonus award level. The potential bonus award level may also be modified by winning the bonus award.

These and other advantages and features of the invention will be apparent from the following description of the preferred embodiments, considered along with the accompanying drawings.

### BRIEF DESCRIPTION OF THE DRAWINGS

FIG. 1 is a view in front perspective of a gaming machine which may be used in a gaming system embodying the principles of the present invention.

FIG. 2 is a diagrammatic representation showing various electronic components of the gaming machine shown in FIG. 1.

FIG. 3 is a flow chart showing game operation according to one embodiment of the invention.

FIG. 4 is a flow chart showing game operation for one bonus play mode.

FIG. 5 is another flow chart showing game operation for a bonus adjustment scheme.

FIG. 6 is a representation of a graphic display having a display matrix and a potential 21 bonus award indicator.

FIG. 7 is a representation of a graphic display with a bonus award event.

FIGS. 8-10 are a sequence of graphic displays used to show a potential bonus award adjustment.

FIG. 11 is a flow chart of an example sequence of game play cycles in a bonus mode.

### DESCRIPTION OF ILLUSTRATIVE EMBODIMENTS

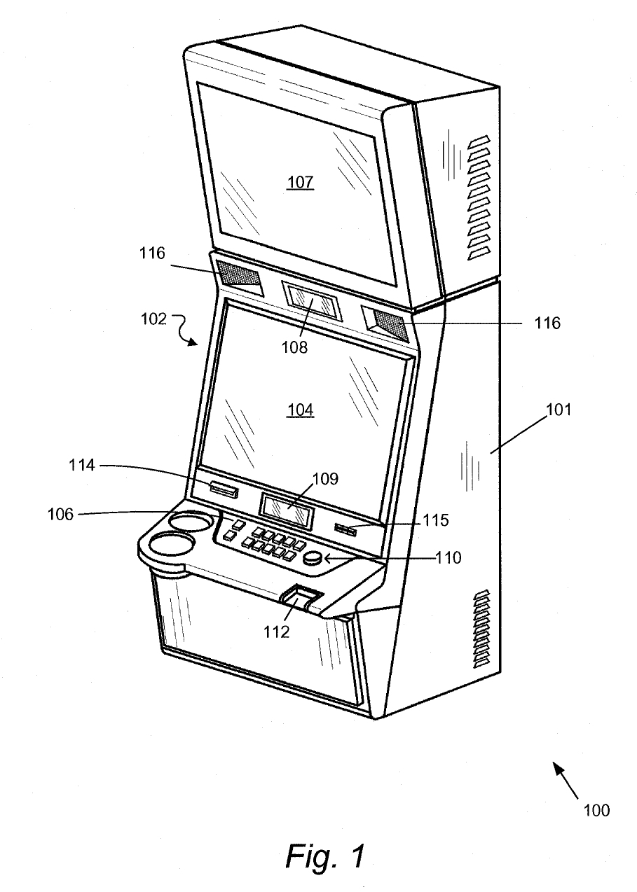

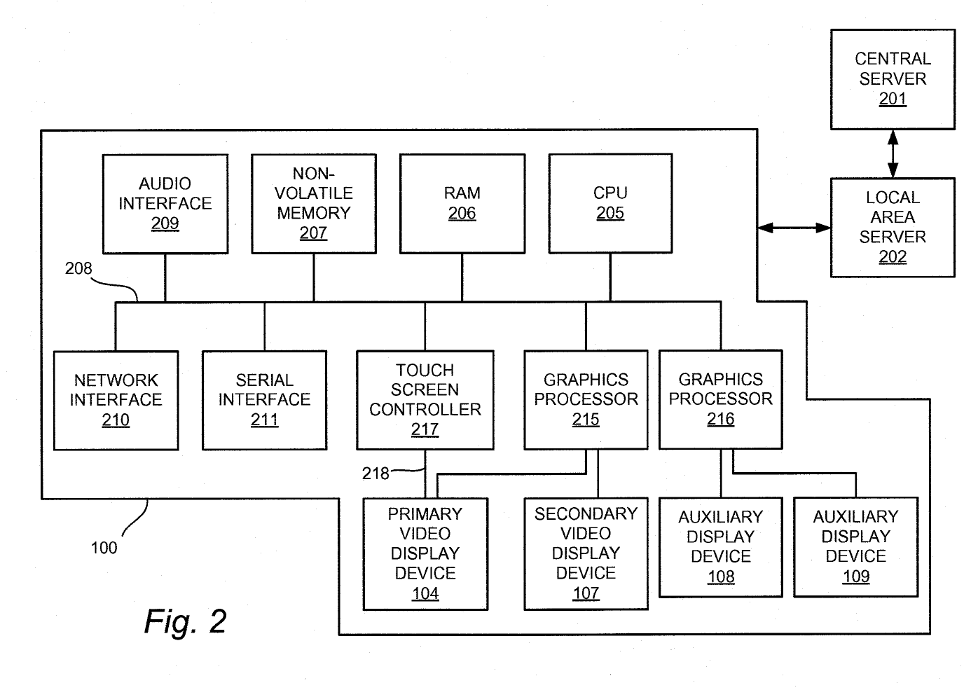

FIG. 1 shows a gaming machine 100 that may be used to present game results according to the present invention. The block diagram of FIG. 2 shows further details of gaming machine 100 connected in a gaming system in which the present invention may be used to present gaming results to players.

Referring to FIG. 1, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that the display devices used herein may include any suitable display device including a cathode ray tube, liquid crystal display, plasma display, LED display, or any other type of display device currently known or that may be developed in the future.

Gaming machine 100 illustrated in FIG. 1, also includes a number of mechanical control buttons 110 mounted on ledge 106. These control buttons 110 may allow a player to select a bet level, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer 13 having a voucher/receipt output 115. Audio speakers 116 generate an audio output to enhance 14 the user's playing experience. Numerous other types of devices may be included in gaming machines that may be used according to the present invention.

FIG. 2 provides a block diagram showing various electronic components of gaming machine 100. In particular, FIG. 2 shows that gaming machine 100 includes a central processing unit (CPU) 205 along with random access memory (RAM) 206 and nonvolatile memory or storage device 207. All of these devices are connected on a system bus 208 with an audio interface device 209, a network interface 210, and a serial interface 211. While a single system bus is shown, of course architectures with north and south-side busses with their accompanying interface chipset(s) are also contemplated. A graphics processor 215 is also connected on bus 208 and is connected to drive the primary video display device 104 and secondary video display device 107 (both mounted on cabinet 101 as shown in FIG. 1). A second graphics processor 216 may also be connected on bus 208 to drive auxiliary display devices, such as devices 108 and 109 shown in FIG. 1, or all displays may be driven with a common graphics processor. Some embodiments may include fewer auxiliary devices. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself includes a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio interface 209, for example, may be connected to the system via a PCI bus. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine.

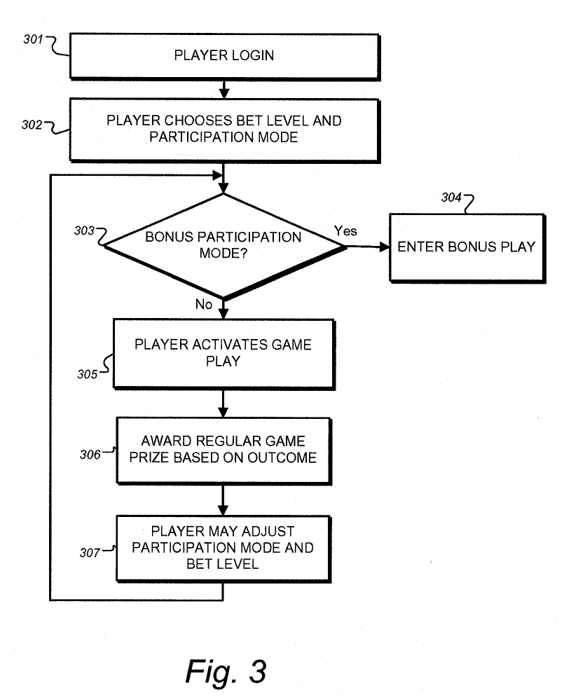

As will be discussed further below, CPU 205 alone or in combination with one or more of the depicted graphics processors may implement a presentation controller which executes display control client code for performing functions associated with a graphically presented game according to the present invention. In the preferred embodiment, processor 205 and graphics processor 215 represent the presentation controller included in the invention. As indicated previously however, the invention is not limited to a presentation controller comprising a general purpose processing device, and is not limited to a presentation controller implemented at the gaming machine 100. Rather, the functions of the presentation controller described herein may be performed at a processing device remote from the gaming machine 100. For example, local area server 202 or central server 201 shown in FIG. 2 may represent the presentation controller according to some forms of the invention. The presentation controller functions may also be split between multiple processing devices remote from the gaming machine 100, or through multiple processing devices at a single location or distributed over a network. CPU 205 also executes software related to communications handled through network interface 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network interface 210 provides an interface to other components of a gaming system such as the servers discussed below in connection with FIG. 3.

FIG. 3 is a process flow chart showing the operation of a gaming machine to provide bonus prize play according to one form of the present invention. The gaming machine may be of the type shown as gaming machine 100 in FIGS. 1 and 2 for example. The process begins with a player login as shown at process step 301 in FIG. 3. The player chooses their bet level and participation mode in step 302. The bet level typically refers to the number of credits the player bets. Bet level may be assigned as a total bet, or, for games with multiple ways to win such as “bet lines,” the bet level may be the number of credits per line. The participation mode refers to the level of game participation selected by the player. Most commonly this refers to the number of bet lines the player is playing. For example many common games have 15 possible bet lines, with the “max lines” participation level being 15 lines, but several lower participation levels also selectable by the player. Other embodiments may have other participation levels which may be selected by the player.

Next, in step 303, the process determines if the player selections have resulted in bonus participation mode of play. If so, the game enters a bonus play mode in step 304, which includes additional features and prizes as described below. The determination in step 303 is preferably based on whether the player has selected the “max lines” participation level. Other embodiments or game versions may provide other bonus-activating modes, such as a less-than-maximum participation level (i.e., 5 lines) combined with a high bet level (i.e., 5 credits per line), for example.

If no bonus participation mode is determined, the process proceeds to step 305 in which the player activates game play. This is typically done by pressing a “play” or “spin” button on gaming machine 100, or a touchscreen button. Any suitable activation sequence may be used. The player command provides a game activation which starts game play and then provides a game result. This combination is referred to as a complete “game play cycle.” Game play may be conducted according to many schemes of providing randomly selected game results. The result is typically matched to a prize level to be awarded to the player. The process at step 306 awards the prize based on the “regular” (non-bonus level) play in step 305. Next, the player may adjust their bet level and participation mode at step 307. After this step, the process then goes back to step 303 and reevaluates whether the player is participating sufficiently to activate bonus play.

The game play cycle will typically include some player input representing a game play request at the gaming machine to initiate a game play. This input may be entered in any suitable fashion at the gaming machine and may include one or more separate inputs. These inputs are entered at a suitable input device at the gaming machine, such as the one or more input devices 109 shown in FIG. 1 and/or a touch screen associated with a game display such as primary video display device 104 as discussed above in connection with FIG. 2. Other embodiments employ a much more streamlined input procedure for initiating a game play. For example, a given game play may be initiated by simply activating a “play” button included in player input devices such as input devices 110 in FIG. 1 and/or included in a touchscreen display. Game play may be conducted according to many schemes of providing randomly selected game results. The result is typically matched to a prize level to be awarded to the player.

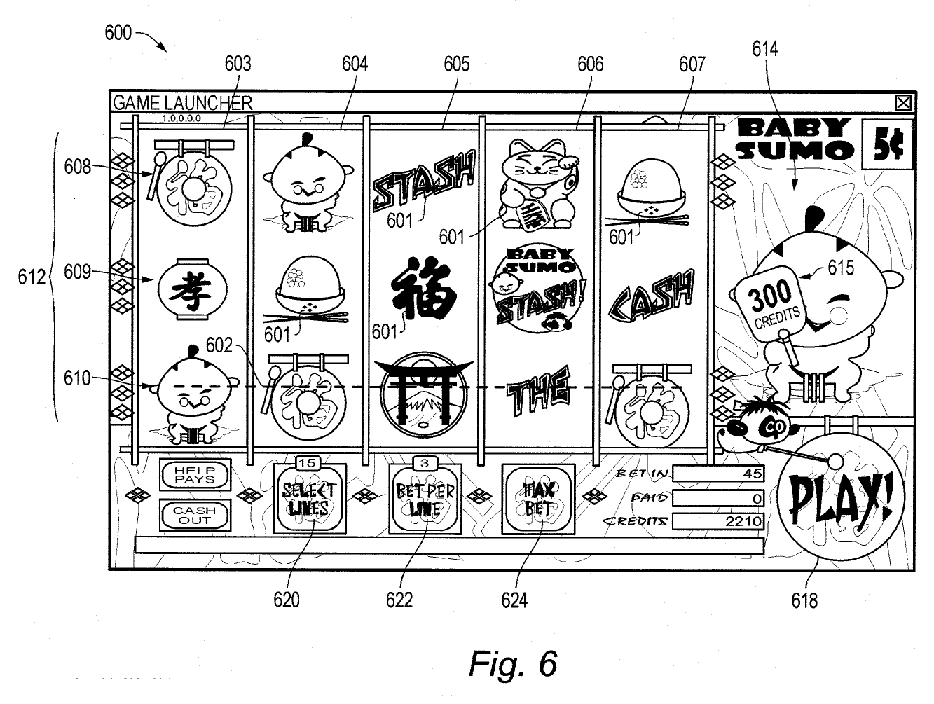

In a preferred game design, a result for the game play in step 305 is displayed with a matrix of game symbol locations, such as that in the example graphic in FIG. 6. According to this embodiment, the result will be displayed at least partially through a symbol matrix displaying multi-symbol reel simulation results. The display matrix is updated to provide symbol changes according to the reel simulation results. An example of such a reel simulation display is further described with respect to FIG. 6. In one preferred embodiment, a presentation controller located at the gaming machine (such as gaming machine 100 shown in FIGS. 1 and 2) and/or located at a central server or local area server (such as servers 201 and 202, respectively, in FIG. 2), causes a display device to display symbol matrix in the pregame state, a simulated spinning state, and a resulting state. Preferably, the presentation controller executes first game program code executable to cause a gaming machine to operate in a in the base game state described with regard to FIG. 3.

One embodiment provides game results by generating a random number, which is matched to an outcome prize level in a prize table. Other embodiments may provide game play by a computerized bingo game with an outcome matched to a certain prize level. Yet another embodiment plays a ticket record having a predetermined outcome. The record may be drawn from record pools on the gaming machine 100 or servers 201 or 202. Any suitable game engine may provide game play. Preferred embodiments display game results to the player by spinning simulated reels and stopping the reels at a pattern with a prize having the determined game outcome prize level. One such reel game is further described below.

In a preferred design, the steps in FIG. 3 are accomplished by first display state control code that is part of the display control client code resident in program memory of CPU 205.

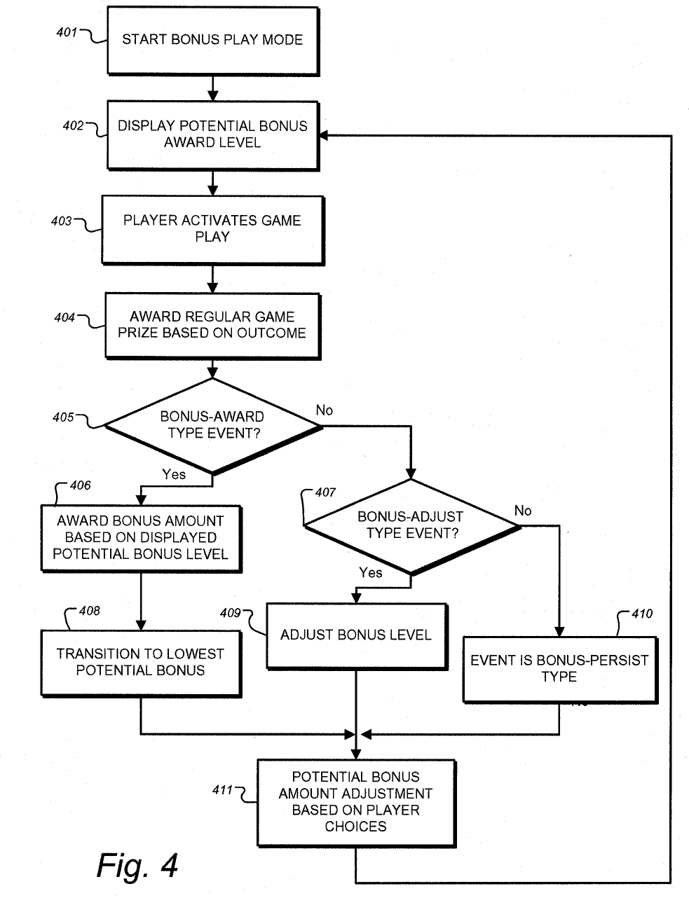

FIG. 4 is a process flow chart of game play in a bonus play mode. In this embodiment, the process in FIG. 4 is entered from step 304 in FIG. 3, but other sequences may occur. Step 401 signifies the start of bonus play mode. Next, at step 402, the process displays a potential bonus award level. This level is preferably randomly selected from a bonus level range based on the player's bet level. Other selecting steps may be used. The display of potential bonus level is preferably located in an area beside the symbol matrix or other game display area, preferably on the same display device. Bonus level display may be accompanied by a multimedia sequence within the game. Such display is further described below.

Next, at step 403, the player provides a game activation through a button or other input. Then, game play proceeds to a result according to whatever game play scheme is employed. Gaming machine operation at step 403 and 404 generally includes a series of steps representing a single game play cycle of the base or “non-bonus” game, with results presented to the player. The game play cycle will typically include some player input representing a game play request at the gaming machine to initiate a game play. This input may be entered in any suitable fashion at the gaming machine and may include one or more separate inputs. These inputs are entered at a suitable input device at the gaming machine, such as the one or more input devices 110 shown in FIG. 1 and/or a touch screen associated with a game display such as video display device 104 as discussed above in connection with FIG. 2. Other embodiments employ a much more streamlined input procedure for initiating a game play. For example, a given game play may be initiated by simply activating a “play” button included in player input devices such as input devices 109 in FIG. 1 and/or included in a touchscreen display.

In a preferred game design, a result for the game play in step 403 is displayed with a matrix of game symbol locations, such as that in the example graphic in FIG. 6. According to this embodiment, the result will be displayed at least partially through a symbol matrix displaying multi-symbol reel simulation results. The display matrix is updated to provide symbol changes according to the reel simulation results. An example of such a reel simulation display is further described with respect to FIG. 6. In one preferred embodiment, a presentation controller either located at the gaming machine (such as gaming machine 100 shown in FIGS. 1 and 2) or located at a local area server or central server (such as servers 200 and 201, respectively, in FIG. 2), causes a display device to display symbol matrix in the first state, the spinning state, and the resulting state.

A preferred embodiment provides game results by generating a random number, which is matched to an outcome prize level. Other embodiments may provide game play by a computerized bingo game with an outcome matched to a certain prize level. Any suitable game engine may provide game play. Preferred embodiments display game results to the player by spinning simulated reels and stopping the reels at a pattern with a prize having the determined game outcome prize level. One such reel game is further described below.

At step 404, the process awards the player the prize associated with the game outcome produced. This is the “regular” or non-bonus prize associated with this game outcome. Some games do not provide a regular prize at this stage, but instead modify the prize based on the bonus level. In such case, step 404 is skipped, and the process goes to step 405 to determine if a bonus award has been won.

At step 405, the process determines if a bonus-award type event has occurred. An event may be a game result or some other type of play event. This embodiment classifies events into three types, “bonus-award,” “bonus-adjust,” and “bonus-persist.” If a bonus-award event has occurred, the process proceeds to step 406 and awards the bonus prize. A preferred embodiment awards an amount equal to the displayed potential bonus amount. Other embodiments may employ the displayed bonus level as a multiplier applied to the regular game result award. In either case, the bonus amount is awarded at step 406.

After the bonus prize is awarded, at step 408, the process transitions to the lowest potential bonus setting for the bet level in use. This provides a bonus prize level “reset” for play in bonus mode after a bonus prize is awarded. Some alternative embodiments may simply exit the bonus mode at step 408. The process for the bonus-award type event next proceeds to step 411, where potential bonus amounts may be adjusted based on changes in bet level and participation mode. Such adjustment is further described below.

Referring again to step 405, if no bonus-award type event occurs, the process proceeds to step 407, which determines if a bonus adjustment type event has occurred. Referring generally to the depicted steps 405, 407, and 410, these steps do not have to occur in the depicted order. Preferably, the event which is classified in these steps is the game outcome. Preferably, the game outcome is determined by a random number generation, which is then mapped to prize levels and bonus events according to a determined probability distribution provided in a prize table. Therefore a certain set of the randomly selected outcomes will be classified as a bonus-award event, and another set classified as a bonus-adjust type event. While the selection process is typically random (i.e., by generating a random number), the prize table containing the outcomes will map the random number onto a desired non-random distribution such that each classification is present in a desired percentage of game outcomes. Another version provides an outcome by assigning a ticket record from a pool of ticket records, each having a predetermined outcome. One variant of such a scheme also includes in the ticket record not only an indicator of the predetermined outcome (prize level and/or bonus prize level), but also an indicator of whether the ticket record is a bonus adjust event, and what type of bonus adjust event. If neither one of the events at step 405 and 407 occurs, the event is classified by default as a bonus-persist type event in step 410, which causes the potential bonus amount to be carried over to the next game play cycle. The bonus-persist event typically has no other affect on the bonus play.

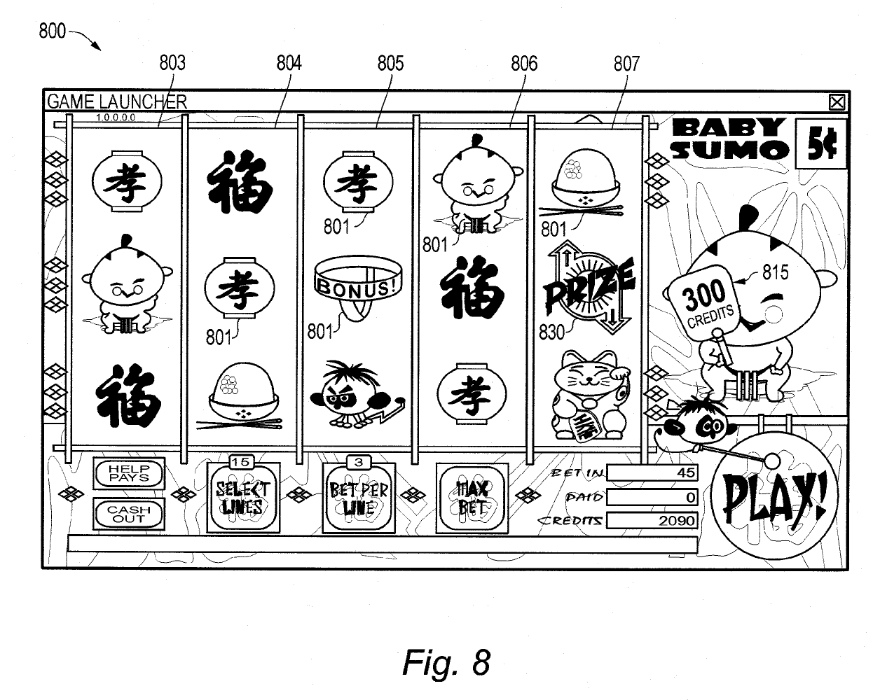

If a bonus-adjust event is found at step 407, then the process proceeds to adjust the bonus level at step 409. In a preferred embodiment, this event is associated with a “change prize” symbol provided on a single game reel, such as, for example, graphic symbol 830 in FIG. 8. The preferred implementation at this step adjusts the potential bonus level by selecting one of 12 bonus levels (at each bet level) through a random selection having a predetermined probability distribution. The bonus level may go up or down. Other adjustment schemes may be used, and this scheme is provided as an example. Preferably, the controller executes second game program code executable to cause a gaming machine to operate in a bonus mode in which a game display device displays the potential bonus award level and makes adjustments depending on the event-type as described herein.

After a bonus level adjustment, the process proceeds to step 411 where player choices may also affect potential bonus levels, as further described below. If neither bonus-award event or bonus-adjust event is detected, the event is a bonus-persist event (step 410) and the process continues to step 411.

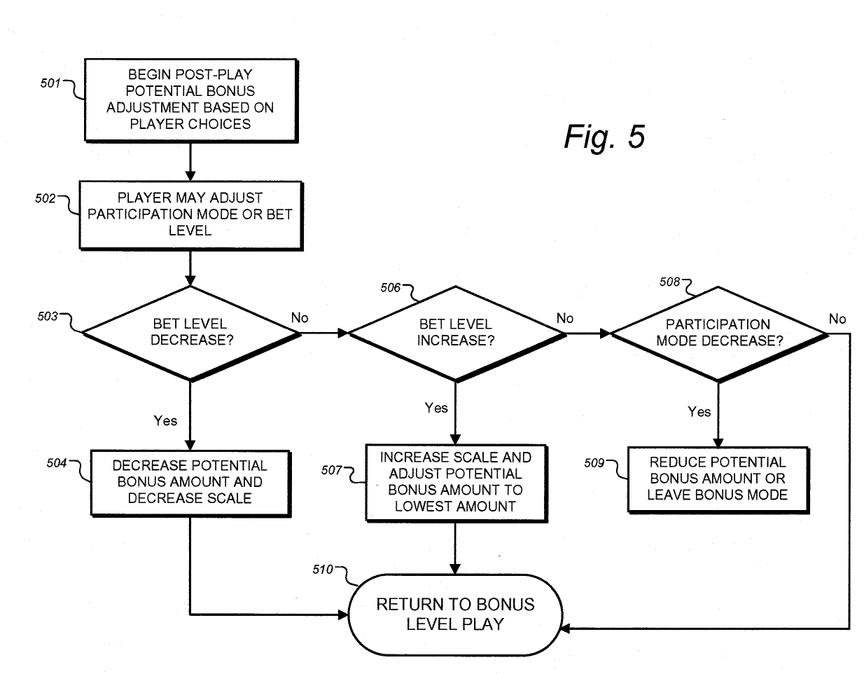

FIG. 5 is a flow chart of a bonus adjustment process. The process shown is one embodiment of what may happen inside step 411 of FIG. 4. The process begins at step 501. Typically, the depicted process is activated in response to post-game bet-level adjustment or participation mode adjustment by the player in step 502. In preferred games, players may adjust bet levels and participation mode after each game play. For example, the player may adjust the bet level through activating the “BET PER LINE” button 622 in FIG. 6, and may adjust the participation mode through activating the “SELECT LINES” button 620, also in the exemplar game graphic of FIG. 6.

The process at step 503 determines if a player decreases their bet level. If so, the potential bonus amount is decreased and the bonus scale is decreased in step 504. Preferably, a different bonus scale is provided for each bet level, and is linearly-sized with respect to the bet level. That is, a bet of two credits will provide a potential bonus scale twice that of a one credit bet, for example. Other adjustment schemes may be used, and the process shown here is merely one example. After the bonus scale adjustment in step 504, the process returns to the bonus level play at step 510.

If no bet level decrease is found at step 503, the process checks for bet level increase at step 506. It should be noted that the decision steps shown may be implemented in a variety of other ways, and in different orders. For example, in an event-driven software design, steps 503 and 504 may occur only in response to bet level adjustment by the player. Any decision flow variation that achieves the results of FIG. 5 is within the scope of this disclosure. If a bet level increase occurs (step 506), the process goes to step 507 where it increases the potential bonus scale to a scale associated with the new bet level. Step 507 also adjusts the potential bonus amount to the lowest amount in the new scale. The process next returns to normal bonus level play at step 510.

If no bet level increase is found at step 506, the process checks for a participation mode decrease at step 508. For example, this occurs if a player decreases the number of lines played in a reel game, or decreases cards played in a bingo game. If the player decreases the participation mode, the potential bonus amount is reduced, or, in a preferred embodiment, the game exits the bonus mode at step 509. This provides a preferred game that provides bonus play only in the max lines participation mode. Other versions may use a different threshold lower than maximum lines participation. Such games may reduce the bonus mode upon a participation decrease, rather than leaving the bonus mode. If the game leaves bonus mode, it returns to normal play mode (i.e., FIG. 3). In the example game herein, when the game exits the bonus mode, the “Baby Sumo” character with the potential bonus award display walks off of the screen and is replaced by alternate graphics. Preferably, the controller executes the second game program code executable to cause a gaming machine to perform the steps of FIG. 5.

FIG. 6 shows a representation of a graphic display 600 showing a potential bonus prize. The graphic display shown in FIG. 6 is a video reel-type display that includes a number of reel symbols 601. Such a graphic display may be generated on a video display device such as video display device 106 shown in FIGS. 1 and 2 in connection with example gaming machine 100. Preferred embodiments provide randomly-determined game results by selecting a random number which indicates, in a prize table, a total prize to be awarded from the prize distribution. The reel stop pattern is then selected to match that prize. Therefore, reel simulators in this embodiment simulate rotation and then display the pattern matched to the selected number.

The reel symbols 601 are provided in symbol locations arranged vertically in columns 603, 604, 605, 606 and 607. Each column, in the display matrix state depicted here, simulates a spinnable reel such as the mechanical reel on a mechanical reel-type machine (slot machine). The reel symbols are also arranged in horizontal rows 608, 609 and 610. This combination of columns and rows represents display matrix 612 of symbol locations. As shown in FIG. 6, the display matrix 612 is created by the combination of five columns and three rows of reel symbols 601, each occupying a symbol location, for example only and not by limitation. Preferably, the simulated reels are aligned so that they spin about a common axis of rotation.

In the depicted preferred game, the potential bonus award, shown as 300 credits, may be won by aligning the three text symbols “STASH,” “THE,” and “CASH,” which are shown not aligned in columns 605, 606, and 607 respectively. This is merely an exemplar preferred bonus award event and other suitable patterns or other game events may be employed as bonus award events.

On the right-hand side of the depicted graphic display 600 are side graphics 614. A “Baby Sumo” character is shown holding the potential bonus award indicator 615. The potential bonus award indicator 615 is displayed when the game enters bonus play mode, as discussed above. In a preferred game, this display occurs when a player plays “max lines” participation mode. Other suitable events may be used to cause bonus mode entry.

A game play is initiated typically through a player game activation at gaming machine 100. The depicted game result shown graphic display 600 is produced by first causing the five simulated reels defined by columns 603, 606, 605, 606 and 607 to appear to spin and then come to rest with a particular set of reel symbols 601 and/or blanks lined up along one or more paylines 602 defined through the display matrix 612. The reel symbols 601 that line up along the payline(s) indicate the result for the game play. A payline may be defined in any manner including two or more symbols as known in the slot machines industry. The depicted payline 602 is shown with a dotted line for example only, the dotted line not typically being part of the game display. A given result can also be displayed by “scatter” symbols displayed anywhere in the display matrix 612 and not necessarily in any line or set relationship.

In addition to display matrix 612, the video device used to generate the graphic display image also provides additional graphic elements around the periphery of the display matrix. In particular, side graphics 614 illustrate a graphical theme, in this example game, having a Japanese-themed graphic including a “Baby Sumo” wrestler. All of the side graphics are consistent with the theme. Other themes may be used in other game embodiments. In this regard, the side graphics may consist entirely of abstract artwork and colors. Further, the side graphics may include one or more repeating figure or design icons or touch screen elements shown generally in area 614 that are consistent with the theme and may be used to facilitate player inputs in the course of play at the gaming machine. “Play” button 618 in the form of a gong, may be invoked by a player to initiate a game play at the gaming machine. “Select Lines” “Bet Per Line” and “Max Bet” buttons 620, 622 and 624, respectively, may also be invoked to choose a bet level in the process of initiating a game play at the gaming machine employing graphic display 600. FIG. 6 also shows other player control touch screen buttons/icons “Cash Out” and “Help Pays” to invoke other common functions available in gaming machine 100 and other types of gaming machines. All of these side graphics 614, however, are part of a graphical theme as presented in a first matrix state on at least two sides of the display matrix 612. FIG. 6 actually shows side graphics in the form of a graphical theme on three sides of the display matrix 612.

The display matrix 612 includes, in this preferred embodiment, multi-symbol reel representations. This means the columns 603-607 are, in one embodiment, each linked to a single respective multi-symbol reel simulator. The vertical combination of symbols in column 603, for example, is three adjacent symbols on a multi-symbol simulated reel. This is not limiting, however, and the bonus schemes described herein may be employed in games with uni-symbol reels or non-reel games. Later Figures will forego labeling various portions of the display and focus on the newly-presented elements.

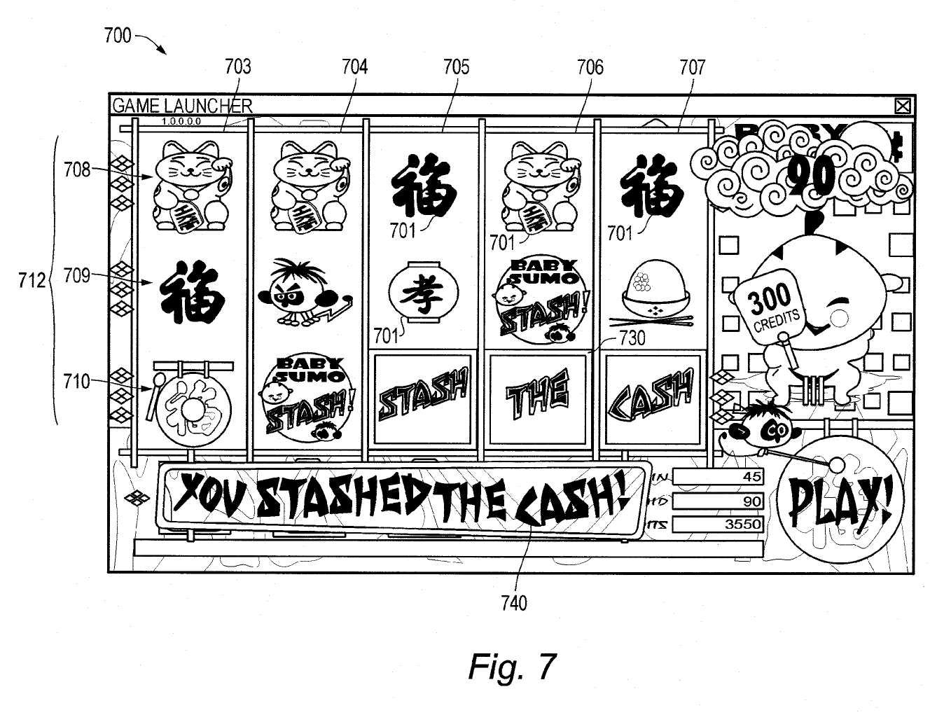

FIG. 7 shows a representation of a graphic display 700 shown with a bonus award event displayed. Graphic display 700 is similar to graphic display 600 with a number of reel symbols 701 arranged in five columns of symbol locations 703, 704, 705, 706 and 707. Three rows 708, 709 and 710 are also displayed.

The symbols shown are the result of a bonus award event in a game play in bonus mode. The boxed symbols 730 aligned to spell “STASH THE CASH” show a winning pattern to the player. Another graphic 740 tells the player they won the bonus prize displayed. While this particular graphic scheme is used in awarding bonus prizes in a preferred game, this is not limiting and other schemes may be used.

FIG. 8 shows a representation of a graphic display 800 resulting from a bonus-adjust event. Graphic display 800 is similar to graphic displays 600 and 700 with a number of reel symbols 801 arranged in five columns 803, 804, 805, 806 and 807, each representing a spinnable reel. In column 807, a bonus adjust symbol 830 is displayed, with the text “PRIZE” and two arrows. In the preferred game, this symbol tells the player a prize adjust event has occurred. The present bonus award indicator 815 is shown held by “Baby Sumo.”

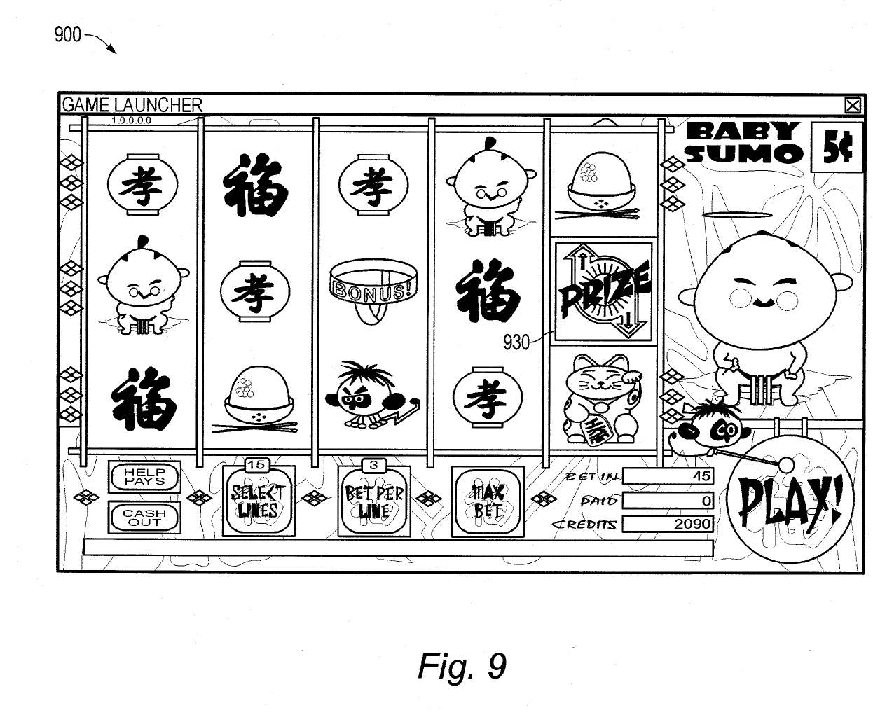

FIG. 9 shows another graphic display 900 appearing in sequence after graphic display 800 in FIG. 8. The depicted display 900 shows a bonus-adjust event in progress. The bonus-adjust symbol 930 is shown boxed, and the “Baby Sumo” character has put away the sign with the potential bonus award amount.

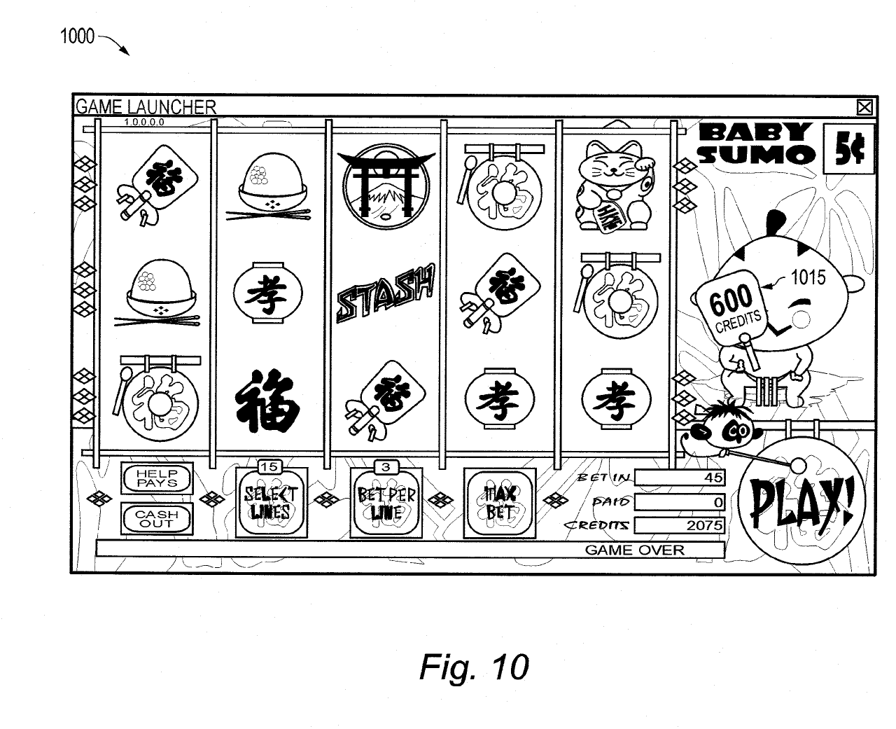

FIG. 10 shows another graphic display 1000 appearing next in sequence after the graphic display 900 in FIG. 9. Depicted is an updated potential bonus value indicator 1015. The 600 value shown has been raised from the 300 value shown in FIG. 8. The bonus adjust procedure may also adjust the potential bonus value downward. This preferred embodiment chooses the updated potential bonus award based on random selection from a set of potential values having a determined probability distribution.

During bonus play, if the bonus-award event (i.e., that shown in the sequence of FIGS. 6-7) or the bonus-adjust event (i.e., that as shown in the sequence of FIGS. 8-10) do not occur in a game, and the player does not alter the participation mode or bet level, the potential bonus award is maintained between game plays.

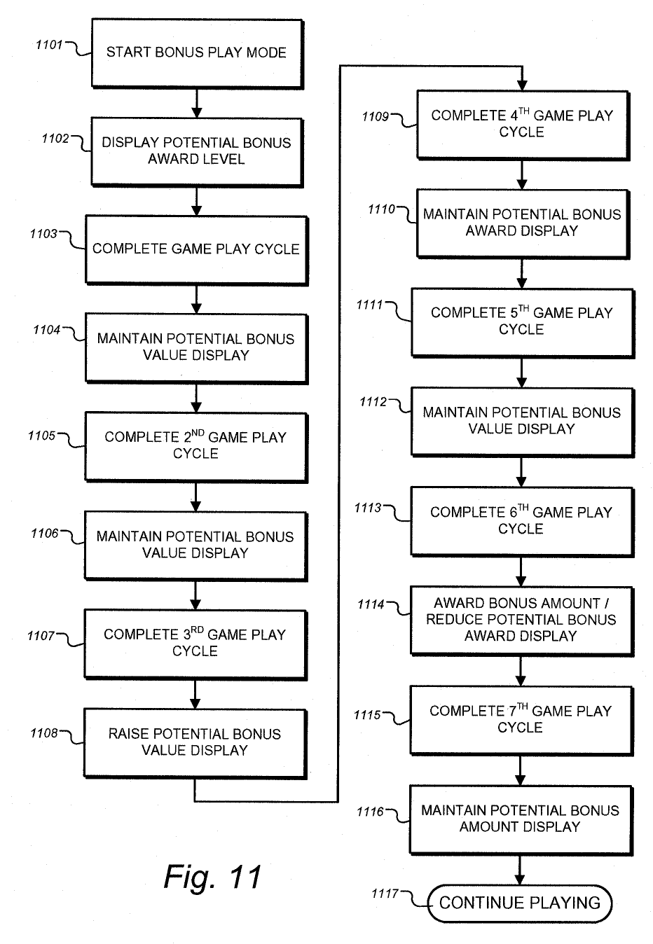

FIG. 11 is a flow chart of one example sequence of game play cycles showing potential bonus award persistence. The sequence in FIG. 11 is merely one example of how multiple game plays cycles might proceed in order, given a particular randomly-determined outcome of each game, and assuming the player does not reduce the participation mode below the “max line” betting that activates bonus mode in the preferred game design.

In step 1101, game machine 100 starts bonus play mode. At step 1102, the game displays the potential bonus award as described herein. At step 1103, the game completes a game play cycle. In preferred games, a game play cycle involves a single “round” or “game” in which the player bets and activates the “PLAY!” button, and then the game provides a result. Other games may include further player interaction with the game during a single game play cycle. For example, a “daubing” step is required in some bingo-based games. Other games such as card games require the player to make and input choices during the course of a game play cycle. “Free spins” or other extra rounds may be included within a single game play cycle in some games.

In FIG. 11, after one complete game play cycle at step 1103, the process maintains the potential bonus award value (and the display of the value) at step 1104. In this sequence, a bonus-persist event occurred during the game play cycle. At step 1105, the process completes another game play cycle, and maintains the potential bonus value again at step 1106, because a bonus-persist event occurred again.

Next in step 1107, the process completes a third game play cycle. In this example sequence of games, the third game play cycle includes a bonus-adjust event, and the potential bonus value is raised in step 1108. Next in step 1109, the process completes a 4^{th} game play cycle. This cycle includes a bonus-persist event, so the potential bonus award display (and the potential bonus award value) is maintained in step 1110. Another game play cycle passes with a bonus persist event in steps 1111 and 1112. Note that any of these cycles may include game prize awards based on the standard game play, but the bonus award has not yet been awarded in this particular sequence.

Next in step 1113, the process completes a 6^{th} game play cycle, in which a bonus award event occurs. This results in a bonus award in step 1114, and a reset of the bonus amount to the lowest available amount for the bet level at which the player is playing. Next, the process completes a 7^{th} game play cycle at step 1115. This game play cycle also provides a bonus-persist event and the potential bonus value is maintained at step 1116. The process may continue indefinitely in bonus play mode at step 1117 until the player reduces their participation mode below “max lines,” or quits playing. Other bonus play thresholds may be used, and “max lines” or “15 lines” are only an example participation mode that activates bonus play in the preferred game herein.

As may be understood from this example sequence, game results in bonus mode may provide for adjustment in potential bonus amount upward (or downward), or may simply maintain the potential bonus amount across multiple game play cycles. The sequence shown in FIG. 11 is merely an example, and randomly-selected results provided by play in bonus mode will provide other sequences of game play cycles.

It should be noted that the invention is not limited to gaming machines employing the personal computer-type arrangement of processing devices and interfaces shown in example gaming machine 100. Other gaming machines may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is only necessary that the gaming machine include one display device that is capable of producing the displays described herein. For example, a gaming machine suitable for use in the invention may include a mechanical reel-type display rather than a video-type display device for displaying results in a primary game. Thus, a gaming machine suitable for use in the present invention may have a structure similar to that shown for gaming machine 100 in FIG. 1, but with a mechanical reel-type display replacing the primary video display device 104.

As used herein, the terms “comprising,” “including,” “carrying,” “having,” “containing,” “involving,” and the like are to be understood to be open-ended, that is, to mean including but not limited to.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1. A method including:
(a) displaying a gaming graphic in a first region of a graphic display device;
(b) displaying a potential bonus award level in a second display region of the graphic display device;
(c) in response to a game event having a first bonus-persists type, maintaining the potential bonus award level;
(d) in response to a game event having a second bonus-award type, awarding an amount based on the potential bonus award level; and
(e) in response to a game event having a third bonus-adjust type, randomly selecting a new potential bonus award level from among a set of potential levels.

2. The method of claim 1 further including, in response to entering a player-chosen bet level adjustment, modifying the potential bonus award level.

3. The method of claim 2 further including, if the bet level adjustment is a downward adjustment, decreasing the potential bonus award proportionally to the bet level adjustment.

4. The method of claim 2 further including, if the bet level adjustment is an upward adjustment, decreasing the potential bonus award downward to a minimum non-zero value.

5. The method of claim 1 further including, in response to entering a player-chosen sub-maximum line participation mode, removing potential bonus award level from the second display region.

6. A method including:
(a) displaying a matrix of symbol locations in a first display region, the symbol locations for displaying symbols based on game events;
(b) in response to entering a player-chosen maximum line participation mode, adding graphics in a second display region to display a potential bonus award level;
(c) after displaying the potential bonus award level, providing a game play cycle in which a non-bonus game prize is awarded and the potential bonus award level is maintained for use in a subsequent game play cycle; and
(d) in response to a game event having a bonus-adjust type, randomly selecting a new potential bonus award level from among a set of potential levels.

7. The method of claim 6, further including, in response to a bonus award event, awarding a prize based on the potential bonus award level, and adjusting the potential bonus award level to a lowest award level associated with a current bet-level.

8. The method of claim 6 wherein the set of potential levels is arranged in a table indexed by a random number and providing a non-random distribution of the potential levels.

9. The method of claim 6 further including, in response to entering a player-chosen bet level adjustment, modifying the potential bonus award level.

10. The method of claim 9 further including, if the bet level adjustment is a downward adjustment, decreasing the potential bonus award proportionally to the bet level adjustment.

11. The method of claim 9 further including, if the bet level adjustment is an upward adjustment, decreasing the potential bonus award downward to a minimum non-zero value.

12. The method of claim 6 further including, in response to entering a player-chosen sub-maximum line participation level, removing potential bonus award level from the second display region.

13. A gaming machine including:
(a) a video display device;
(b) a player interface; and
(c) a presentation controller, the presentation controller for (i) causing the video display device to display a gaming graphic in a first region and for (ii) in response to entering a player-chosen maximum line participation mode, causing the video display device to display a potential bonus award level in a second display region of the graphic display device and for (iii) in response to a game event having a first bonus-persists type, maintaining the potential bonus award level for application to a subsequent game play cycle.

14. The gaming machine of claim 13 in which the presentation controller is further for, in response to a game event having a bonus-adjust type, randomly selecting a new potential bonus award level for application to a subsequent game play cycle from among a set of potential levels.

15. The gaming machine of claim 14 wherein the set of potential levels is arranged in a table adapted for indexing by a random number and for providing a non-random distribution of the potential levels.

16. A program product embodied in one or more computer readable media, the program product including:
(a) first game program code executable to cause a gaming machine to operate in a game play mode in which a game display device displays a gaming graphic in a first region of a graphic display device; and
(b) second game program code executable to cause a gaming machine to operate in a bonus mode in which a game display device displays a potential bonus award level, and further cause the gaming machine to, in response to a game event having a first bonus-persists type, maintaining the potential bonus award level, and further cause the gaming machine to, in response to a game event having a second bonus-award type, awarding an amount based on the potential bonus award level, and further cause the game to, in response to a game event having a third bonus-adjust type, randomly selecting a new potential bonus award level from among a set of potential levels.

17. The program product of claim 16 wherein the second game program code is further executable to access a table providing a non-random distribution of the set potential levels set using a random number.

18. The program product of claim 16 wherein the second game program code is further executable to, in response to receiving an indication of a player-chosen bet level adjustment, modify the potential bonus award level.

19. The program product of claim 18 wherein the second game program code is further executable to, if the bet level adjustment is a downward adjustment, decrease the potential bonus award proportionally to the bet level adjustment.

20. The program product of claim 18 wherein the second game program code is further executable to, if the bet level adjustment is an upward adjustment, decrease the potential bonus award downward to a minimum non-zero value.

21. The program product of claim 18 wherein the second game program code is further executable to, in response to receiving an indication of a player-chosen sub-maximum line participation level, remove potential bonus award level from the second display region.
